(19) United States
(12) Patent Application Publication
(10) Pub. No.: US 2005/0241496 A1
(43) Pub. Date: Nov. 3, 2005

(54) Restaurant with decentralized cooking system

(76) Inventors: Zhaoxia Xu, Ypsilanti, MI (US); Zheng Peng, Ypsilanti, MI (US)

Correspondence Address: ZHAOXIA XU, 4694 SYCAMORE DR., YPSILANTI, MI, 48197, US

(21) Appl. No.: 10/709,304

(22) Filed: Apr. 28, 2004

(51) Int. Cl. A23L 1/00

(52) U.S. Cl. 99/485

(57) ABSTRACT

A restaurant (300) and a restaurant method. Restaurant (300) comprises a dining area (302) defined by a restaurant building (304), a plurality of dining tables (306) disposed in dining area (302), a plurality of cooking stations (312), of which each cooking station is disposed at an appropriate location on each of dining tables (306), such that diners are provided with options to select and cook foods by themselves, and whereby each dish is individually cooked and customized to diners preference.

### BACKGROUND OF INVENTION

This invention generally relates to restaurants. More specifically, this invention relates to restaurants with decentralized cooking systems, such that diners are provided with options to select and cook foods by themselves, whereby each dish is individually cooked and customized to diners' preference.

Conventional restaurants have centralized kitchens. Dishes are prepared in a remote kitchen in batches and then carried out to diners in a separate dinning area by waiters/waitresses.

A close look at a typical dining experience with a full service restaurant reveals several instances where a diner may become frustrated with the service as a result of being in a position where the diner has to wait for a server to perform.

Other types of restaurants include primarily fast food and buffet-style restaurants.

Fast food is popular because it takes less time to prepare and it is relatively inexpensive. Buffets are becoming more and more popular nowadays because buffets allow diners to try many different dishes, rather than being limited to a single dish or predefined combinations when ordering from a menu.

However, foods provided by many of these conventional restaurants are generally believed to be unwholesome, usually too fatty, especially for some fast food restaurants. Fast food industry is currently under pressure from general public about the foods they are providing. There is an ever-increasing concern over the amount of oil or fat in one's diet. In particular, a low fat diet is desirable in light of related health concerns, such as obesity, overweight, diabetes, etc.

Another drawback associated with conventional restaurants is that diners have little, if not none, control over the ingredients in dishes they have ordered, because dishes are usually prepared by professional chefs in a remote kitchen based on predefined menus. Some diners are alergic to some specific additive ingredients.

On the contrary to conventional restaurants are restauants that have decentralized cooking systems, in which dishes are prepared in multiple locations closer to dining areas, or by diners themselves.

There are many benefits associated with restaurants having decentralized cooking systems. First, diners waiting time could be significantly reduced; second, diners have more control over the ingredients in their dishes; third, each dish is individually cooked and customized to diners preference; and fourth, the operation cost of restaurants can be reduced.

However, there are some important hurdles, which have limited the level to which the cooking system of a restaurant can be decentralized.

First, cooking processes require considerable skills in judging the progress of a dish by the smell, look and feel of the food, and the sound of the cooking, especially for stir-frying, such as preparing Chinese foods, which is the brisk cooking of small cuts of meats and vegetables in hot oil over intense heat, calling for split-second timing and swift movements in an uninterrupted rhythm. Therefore, excessive decentralization may prohibitively increase the number of professional chefs required by a restaurant and consequently the cost of restaurant operation.

Were there a way to capture and multiply the knowledge and the skills of a good chef, a whole new opportunity would be created for further expansion of restaurant industries and the level of decentralization of restaurant cooking systems can be further increased.

Second, the contact of moisture-containing raw foods with hot oil produces grease splattering. Most times, the splattering liquids and food particles reach out of cooking apparatuses to considerable distances. These will not only mess up surrounding surfaces but also create undue oil burn injuries to the people who are preparing foods.

Third, oil vapor is produced when oil is heated, causing long-term hazards to peoples health and to restaurant environment, as well.

Over years, various cooking apparatuses have been developed to address some of these problems. The latest development in automatic cooking apparatuses has been well documented in the following two US patent applications.

U.S. patent application Ser. No. 10/604,389, filed by Zhaoxia Xu and Zheng Peng, on Jul. 17, 2003, teaches an automatic frying apparatus for both deep and shallow frying. The frying apparatus comprises a container for holding foods, a lid covering on top of the container, a bottom heating device installed underneath the container, a stirring blade rotatably and removably installed inside the container for stirring foods, a power-drive assembly operationally coupled with the stirring blade for driving the stirring blade through repeating stirring cycles, a blowing device for forcing fresh air into the frying apparatus for the removal of moisture inside the container, and a venting device for filtering and deodorizing cooking fumes.

U.S. patent application Ser. No. 10/709,085, filed by Zhaoxia Xu and Zheng Peng, on Apr. 12, 2004, teaches a stir-frying apparatus with a bottom heating device and an overhead-heating device. Based on extensive testing results, this stir-frying apparatus can fry foods much more efficiently than apparatuses having just a bottom-heating device and has reduced the cooking time required for a dish to 4 to 6 minutes.

Therefore, it remains desirable to provide a restaurant that has a decentralized cooking system, in which diners are provided with options to select and cook foods by themselves, such that diners waiting time is reduced, each dish is individually cooked and customized to diners preference, and the cost associated with restaurant operation is reduced.

### SUMMARY OF INVENTION

Accordingly, the present invention is a restaurant method. The restaurant method includes steps of providing a dining area defined by a restaurant building, providing a plurality of dining tables disposed in the dining area, providing a plurality of seats disposed around each of these dining tables, and providing a plurality of cooking stations with each disposed on each of these dining tables, wherein each of these cooking stations includes a container having an open top for holding foods, a lid covering on top of the container for closing up the open top, a bottom heating device installed underneath the container for heating foods from below and an overhead heating device installed at an upper position of the cooking station for heating foods from above, a stirring blade rotatably and removably installed inside the container for stirring foods, a power-drive assembly operationally coupled with the stirring blade for driving the stirring blade through repeating stirring cycles, and a venting device for filtering and deodorizing cooking fumes; such that diners are provided with options to select and cook foods by themselves and whereby each dish is individually cooked and customized to diners preference.

A restaurant comprising a dining area defined by a restaurant building, a plurality of dining tables disposed in the dining area, a plurality of seats disposed around each of the dining table, a plurality of stir-frying apparatuses with each disposed on each of the dining tables, wherein each of the stir-frying apparatuses includes a container having an open top for holding foods, a bottom heating device installed underneath the container for heating foods from below and an overhead heating device installed at an upper position of the stir-frying apparatus for heating foods from above, a stirring blade installed inside the container for stirring foods, a power-drive assembly operationally coupled with the stirring blade for driving the stirring blade through repeating stirring cycles cles, and a heating device for heating foods disposed inside said container, wherein diners are provided with options to select among raw foods and additive ingredients and to cook dishes by themselves, and whereby each dish is individually cooked and customized to diners preference.

Accordingly, the followings are some of the objects, features, and advantages of the present invention.

It is an object of the present invention to provide a restaurant method for providing diners with individually cooked dishes that are more wholesome and tasteful.

It is another object of the present invention to provide a restaurant method that will reduce diners waiting time.

It is a further more object of the present invention to provide a restaurant method that will reduce restaurant operation costs.

It is a feature of the present invention that in the restaurant method each dining table is equipped with a cooking station, such that diners are provided with options to cook by themselves and whereby each dish is individually cooked and customized to diners preference.

It is another feature of the present invention that in the restaurant method raw foods and additive ingredients are pre-packed in bags that are adapted for individual dishes, such that the raw foods can be prepared in a remote factory.

It is an advantage of the present invention that this restaurant method saves diners time.

It is another advantage of the present invention that this restaurant method provides diners with healthy foods.

It is a further more advantage of the present invention that this restaurant method provides diners with the benefits of both fast food restaurants and sit-down full service restaurants.

It is a still more advantage of the present invention that this restaurant method is easy to franchise.

Further more features and advantages of the present invention will be readily appreciated, as the same becomes better understood after reading the subsequent description when considered in connection with the accompanying drawings.

### BRIEF DESCRIPTION OF DRAWINGS

FIG. 1 illustrates a plan view of an embodiment of the present invention, restaurant 300.

FIG. 2 illustrates a plan view of an individual table of dining tables 306 in FIG. 1.

FIG. 3 illustrates a plan view of another embodiment of the present invention, restaurant 350.

FIG. 4 illustrates a cross-sectional view of a cooking station, stir-frying apparatus 100.

FIG. 5 illustrates a cross-sectional view of stir-frying apparatus 100, taken along line A-A of FIG. 4.

FIG. 6 illustrates a plan view of stir-frying apparatus 100.

FIG. 7 illustrates a blocked diagram of control circuit 162 for stir-frying apparatus 100.

FIG. 8 illustrates a schematic diagram of control circuit 50 for providing an intermittent operation of blade sweeping for stir-frying apparatus 100.

### DETAILED DESCRIPTION

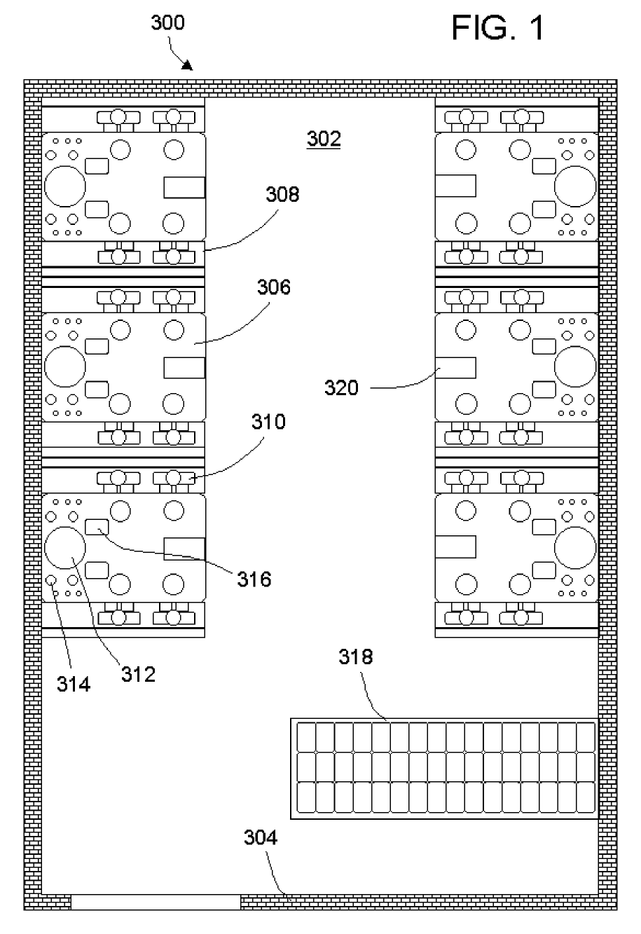

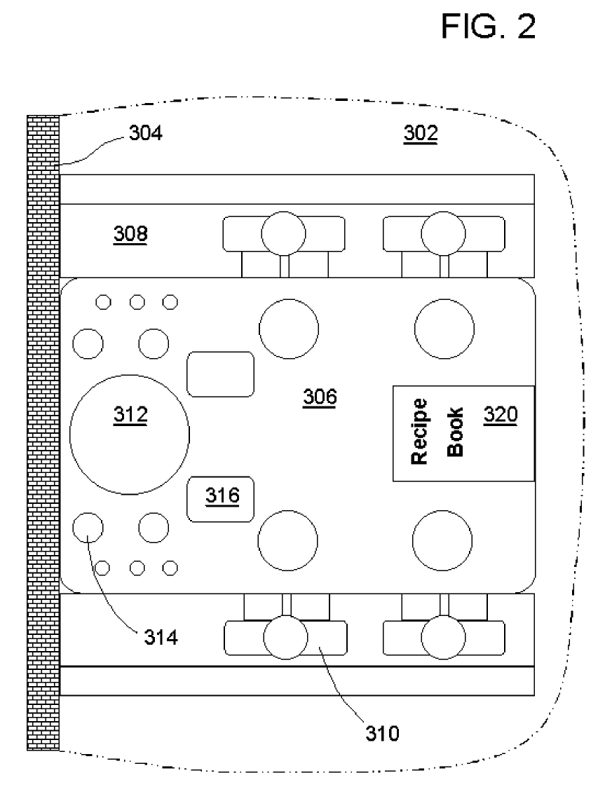

Reference is made to FIG. 1 and FIG. 2. FIG. 1 illustrates a plan view of an embodiment of the present invention, restaurant 300, and FIG. 2 illustrated an exploded plan view of an individual dining table.

A dining area 302 is defined by a restaurant building 304.

A plurality of dining tables, generally designated as 306, is provided in dining area 302. A plurality of seats, generally designated as 308, is provided and disposed around each dining table for seating diners 310.

A plurality of cooking stations 312 is provided for dining tables 306, with one cooking station for each dining table.

Cooking stations 312 can be disposed on dining tables 306 or can be an integrated portion of dining tables 306.

Each dining table is provided with various additive ingredients, designated as 314. Some of ingredients 314 are pre-packed in bags that are adapted for individual dishes, while others might be stored in bottles or cups, such as frying oil, soy sauce, etc.

Diners 310 are provided with raw foods 316, which can be acquired from a bar 318 in dining area 302. Raw foods 316 are either pre-packed in bags that are adapted for individual dishes or stored in utensils, like plates, bows, cups, etc.

Dining tables 306 are provided with recipe books, designated nated as 320, such that diners 310 can cook various dishes based on the recipes in recipe books 320. Recipe books 320 can be replaced with computers, disposed at appropriate locations on dining tables 306, which are pre-loaded with recipes and related cooking information.

A kitchen (not shown) can be provided and adapted for various service needs, such as washing tableware and cooking utensils, providing diners with some customized food items, etc.

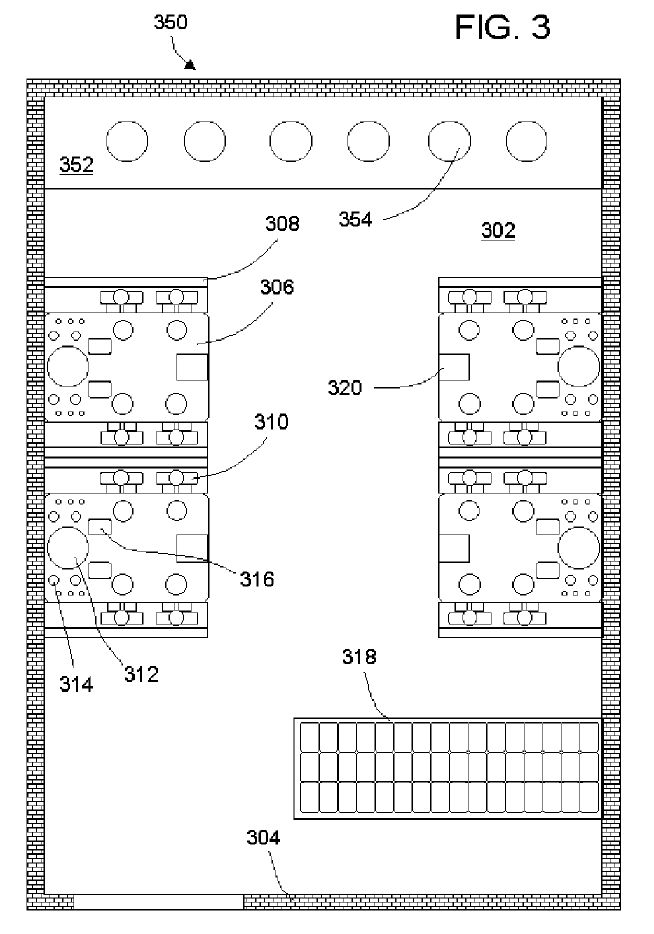

Reference is made to FIG. 3, which illustrated another embodiment of the present invention, restaurant 350. Similar components are denoted with similar reference numbers for avoiding repetitive explanations. Reference is made to restaurants 300 of FIG. 1 for detailed information about these similar components.

A counter desk 352, having a counter top, is provided in dining area 302, disposed at an appropriate location. A plurality of cooking stations 354 is provided and disposed on top of counter desk 352. Diners 310 can cook their dishes using cooking stations 354 for dining in or for carrying out. Other features of restaurant 350 are similar to restaurant 300.

The selection of cooking stations 312 and 354 is very important. Cooking stations 312 and 354 should meet some specific requirements, such that cooking stations 312 and 354 can be used for the purpose of the present invention. The requirements include, but not limited to, cooking fume free, splashing free, convenient to use, highly efficient in preparing foods, capable of being used for a wide range of applications, etc.

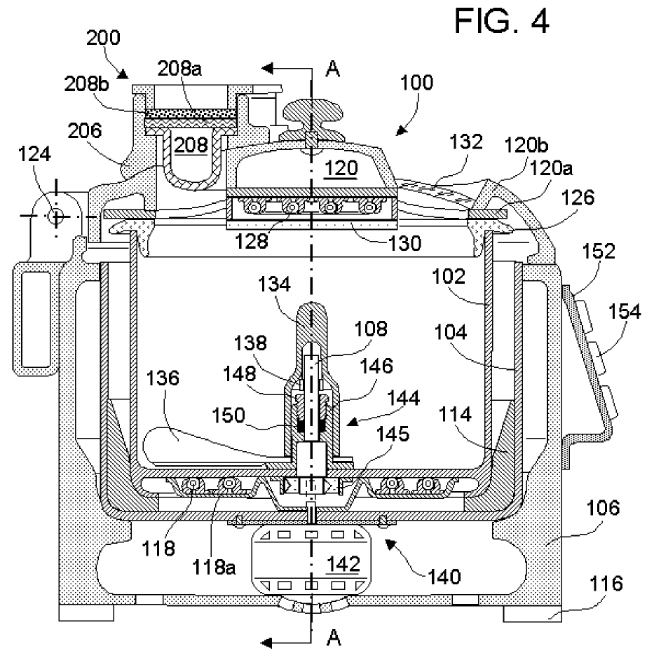

Reference is made to FIGS. 4-6, which illustrate an embodiment of a cooking station of cooking stations 312 and 354, a stir-frying apparatus 100.

Reference is made to FIG. 4, which illustrates a cross-sectional view of apparatus 100.

Container 102, having an open top and a central bottom aperture, is provided for holding foods. Container 102 is installed inside an outer container 104, which is installed inside a housing 106. The central bottom aperture is provided to allow a drive shaft 108 to thread therethrough. Container 102 is, preferably, coated with a non-stick material.

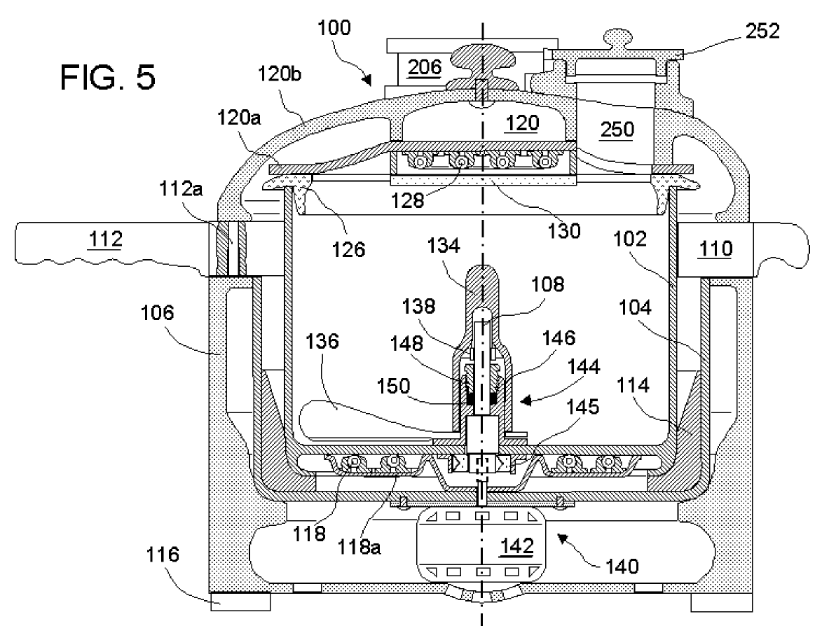

As shown in FIG. 5, which illustrates a cross-sectional view of apparatus 100, taken along line A-A of FIG. 4, a lift handle 110 is installed on one side of container 102, at an upper position. Handle 110 extends from container 102 to outside apparatus 100 through a recession on the upper edge of container 104 and a corresponding recession on the upper edge of housing 106. A grasp handle 112 is installed on the other side of container 102, at an upper position. Handle 112 extends from container 102 to outside apparatus 100 through corresponding recessions on the upper edges of container 104 and housing 106. Handle 112 is lockably hinged, via hinge 112a, at a position close to container 102, such that handle 112 can be folded down or sideways to save some space when apparatus 100 is in a packed state.

A spacing element 114, installed in between containers 102 and 104, is provided for positioning and holding container 102 inside container 104.

A housing support 116, installed on the outside bottom of housing 106, is provided for furnishing a bottom support for apparatus 100, such that apparatus 100 is adapted to stand on a flat surface, e.g., a kitchen counter top.

A bottom-heating device 118, installed on a bracket 118a in between containers 102 and 104, around the central bottom thereof, is provided for heating foods disposed inside container 102 from below. Heating device 118 is in a heat-transferable condition, e.g., in physical contact or radiation, with the bottom of container 102, such that when heating device 118 heats up upon connection with an electricity source, foods therein will also heat up. Heating device 118 can be electrical resistance type heaters or many other types, such as high-intensity infrared lamps or magnetic heating devices, as known to those skilled in the art and suggested by this invention disclosure.

Reference is made to FIG. 4, again. A lid 120, having an inner lid 120 a and an outer lid 120b, is provided for covering on top of container 102 for closing up the open top thereof. Lid 120 a is installed on lid 120b, which is hingedly installed on housing 106 via hinges 124. A seal element 126, installed on lid 120a, is provided for sealing in between lid 120 and container 102.

An overhead-heating device 128, installed on lid 120 a, is provided for heating foods disposed inside container 102 from above. Heating device 128 is preferably in a radiation heat-transferable condition with foods, such that when heating device 128 heats up upon connection with an electricity source, foods therein will also heat up. Heating device 128 can be electrical resistance type heaters or many other types, such as high-intensity infrared lamps, as known to those skilled in the art and suggested by this invention disclosure. A covering piece 130, made of an infrared transparent material, is provided to protect heating device 128 against liquid splattering.

An observation window 132, made of a transparent material, is installed on lid 120 for observing frying processes therethrough by users.

Also illustrated in FIG. 4 is a venting device 200. Venting device 200, installed on lid 120, is provided for exhausting cooking fumes. Detailed discussion about venting device 200 shall be provided later on.

A coupling device 134 is provided for coupling drive shaft 108 and a stirring blade 136 for transferring rotation power. The lower portion of coupling device 134 generally forms a cylindrical configuration or any other suitable configurations and is engaged with blade 136. A coupling element 138 on coupling device 134 is provided for lockably receiving shaft 108.

Blade 136, rotatably and removably installed inside container 102 on the central bottom thereof, is provided for stirring foods. The design of blade 136 can be substantially different, as known to those skilled in the art. The front portion of blade 136 is close to the bottom of container 102 with a small-predetermined clearance for better scooping up food pieces. The rear portion of blade 136 extends gradually upward and serves for lifting up/turning over food pieces. The clearance between the front portion of blade 136 and the bottom of container 102 is minimized for ideal performance.

The speed, at which blade 136 sweeps across food pieces, is important. For too low speeds, blade 136 cannot scoop up food pieces and therefore food pieces cannot be agitated adequately to achieve the desired effect of homogeneous heating. Co-rotation of food pieces with blade 136, as blade 136 rotates, is another important issue needs to be solved. Therefore, a higher speed is desirable for better performance of scooping up food pieces. However, for continuous operation of blade sweeping, when the speed is high, food pieces are agitated too much, for too long time, such that the texture of food pieces could be damaged.

To solve this dilemma, an intermittent operation of blade sweeping is proposed in this invention disclosure. In this intermittent operation, blade 136 dwells for a predetermined interval of time after one or two rounds of sweeping, referred to as one stirring cycle, and then automatically begins another cycle of operation. This intermittent operation affords relief from constant stirring of food pieces at a higher speed, prolongs the utility life of blade 136 and a power-drive assembly 140, and saves some energy required for driving blade 136, as compared with a continuous operation. This intermittent operation also favors foods of great texture because during the predetermined dwell period, the food pieces have adequate time to be heated; which, in turns, favors foods of great looking. A computer control method and an electronic control circuit for achieving this intermittent operation shall be disclosed later on, when the control portion of apparatus 100 is discussed.

Power-drive assembly 140 includes drive shaft 108 and a drive motor 142.

Motor 142 is installed on the outside bottom of outer container 104. The motor shaft of motor 142 threads through a central aperture on the bottom of container 104 and is coupled with drive shaft 108 through a proper coupling mechanism.

Drive shaft 108 is operationally coupled with motor 142, directly for a low-speed motor or via some gears or belt-pulley devices for a high-speed motor. The upper portion of drive shaft 108 is engaged with coupling device 134 via coupling element 138. Drive shaft 108 is installed on container 104 via a bearing element 145.

A seal device 144 is provided for sealing between shaft 108 and container 102. Seal 144 comprises a seal flange 146, a gland nut 148, and a compression packing 150.

Flange 146 is co-axial to shaft 108. The first end of flange 146 is sealingly installed on the inside surface of the central bottom of container 102. The second end of flange 146 emanates upwards to a predetermined height above the bottom of container 102. Gland nut 148 is engaged with the second end of flange 146 by means of screw. Packing 150 creates a seal by being squeezed between the throat of the stuffing box formed by flange 146 and gland nut 148. The squeeze force pushes the material of packing 150 against the throat of the box and rotating shaft 108.

When leakage occurs, gland nut 148 is tightened further. This is a typical application of compression packings for low speed rotating shafts, such as shaft 108.

Materials are extremely important when selecting the proper packing for an application. Metallic packings are used in high-temperature applications. Shafts for copper and aluminum packings must be hardened to 500 Brinell hardness number (Bhn). Copper and aluminum packings can handle 538° C. (1000° F.) application temperature.

Seal 144 can, alternatively, take many other forms, such as bushing and labyrinth seals, or combinations of multiple forms for ideal performance, as known to those skilled in the art and suggested by this invention disclosure.

There is an important advantage of installing seal 144 inside container 102. For most applications, seal 144 is disposed higher than hot liquids, such that the sealing surface is not immersed in hot liquids. Therefore, the requirement on seal 144 is significantly reduced. In addition, shaft 108 is much better supported at a higher position. In operation, the lower portion of coupling device 134 is routed over seal 144.

As shown in FIG. 4, venting device 200 includes a venting conduit 206 and a venting filter 208. The first end of venting conduit 206 is mounted on lid 120. There is an opening on lid 120 in line with venting conduit 206 for allowing cooking fumes to be forced out therethrough. Venting conduit 206 also serves as a bracket for holding venting filter 208. Venting filter 208 is removably engaged with venting conduit 206. Venting filter 208 further includes a disposable paper or fabric filter 208a and/or a disposable activated charcoal filter 208b, together, forming an integrated multi-stage filtering system.

Venting filter 208 is provided to trap the grease impurities in the grease-laden air forced out from inside apparatus 100. Venting filter 208 is, preferably, made of one or multiple layers of metal meshes, such as aluminum ones. Metal meshes have different sizes of meshes and overlap each other. When cooking fumes pass therethrough, the oil particles will be trapped thereon. Filters 208a and 208b are provided to further remove the remaining oil vapor and chemical contents in cooking fumes and for the removal of cooking fume odors before the air is exhausted into the room.

Venting device 200 can be alternatively installed on apparatus 100 at many other proper positions. For example, venting device 200 can be alternatively installed on an upper portion of container 102. These variations are, therefore, covered by this invention disclosure.

Reference is made to FIG. 5. An ingredient-adding conduit 250, installed on lid 120, is provided for use to add ingredients, such as salt, pepper, soy sauce, etc., during a frying process. A cap 252 is provided for closing up conduit 250 when conduit 250 is not in use.

Reference is made to FIG. 4, again. A control housing 152 is provided for housing electrical control devices or elements and supporting a control panel 154. Control housing 152 is installed on the sidewall of housing 106. Control panel 154 is provided for supporting elements, like switches, indicators, adjusting knobs, beepers, LCD, and so on.

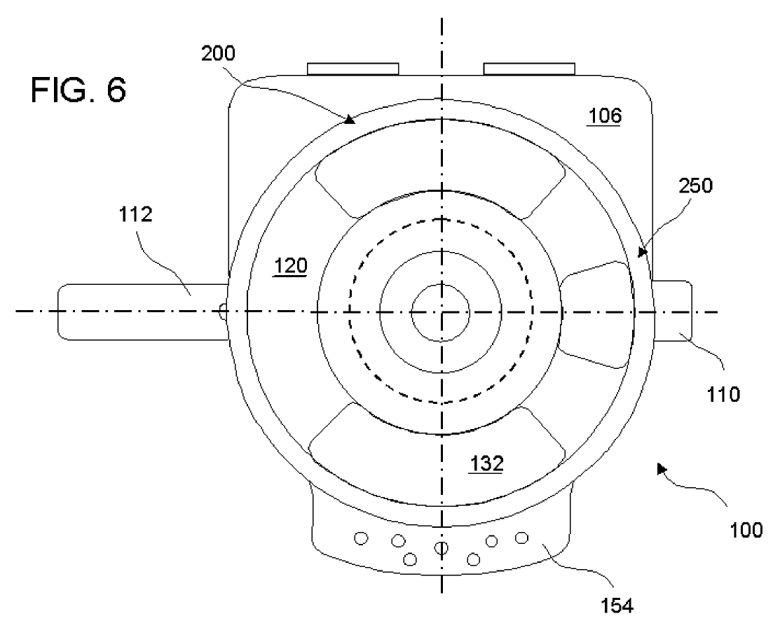

FIG. 6 illustrates a plan view of apparatus 100, indicating the layout of various components/devices of apparatus 100.

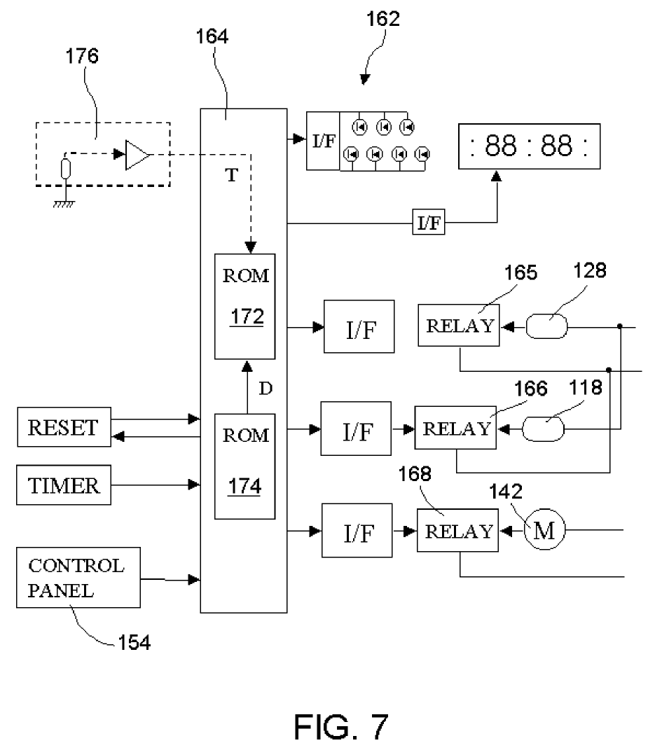

FIG. 7 illustrates a block construction diagram of a control circuit 162 for controlling various functions of apparatus 100, such as the temperature for frying foods and motor speeds for rotating blade 136, etc. Circuit 162 comprises a microcomputer 164, which controls various functions of apparatus 100, a relay 165, which activates heating device 128,a relay 166, which activates heating device 118, and a relay 168, which activates motor 142.

Microcomputer 164 is provided with ROM and RAM for data memory, and further provided with I/O ports A/D converters as interfaces. The aforementioned ROM's comprises a ROM 172 containing control programs related to the performance of frying processes and a ROM 174, which memorizes referenced data.

A temperature sensor 176, disposed at a proper position, is provided for measuring the temperature inside container 102, which is taken by microcomputer 164, as an input variable to be controlled. When the temperature is above the user's desired one, the electrical power to heating devices 118 and 128 will be shut down by relays 165 and 166 to better meet the user's desired frying requirement and to save energy.

Computer 164 can be such programmed that relay 168 activates motor 142 intermittently with a bias toward a longer dwell after each stirring cycle of one or two rounds of rotation.

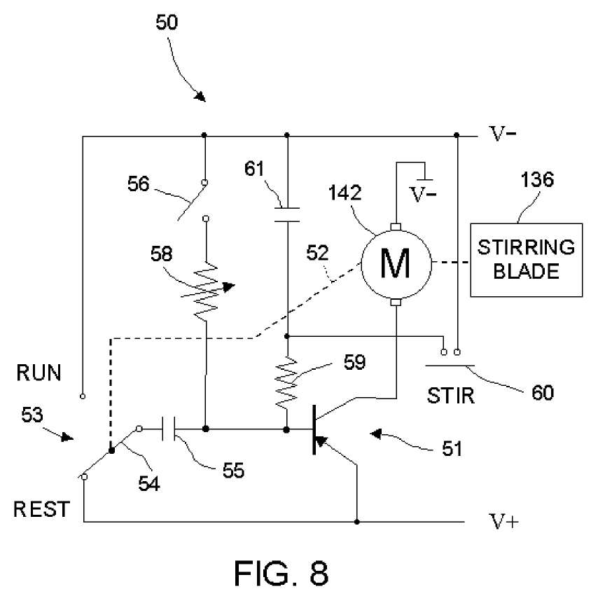

Reference is made to FIG. 8, which illustrates a schematic diagram of a control circuit 50 for providing the intermittent operation of blade sweeping for apparatus 100.

As shown in FIG. 8, drive motor 142 is operationally coupled with blade 136 for providing rotation power. Motor 142 has a first terminal, which is connected to V−, the negative pole of a power source, and a second terminal, which is connected to the collector terminal of a PNP bipolar transistor 51. The emitter terminal of transistor 51 is connected to V+, the positive pole of a power source. Associated with motor 142 is a linkage mechanism 52, which cooperates with a single pole, double throw switch 53, such that the shaft angle of motor 142 controls the switching position. Switch 53 includes a single pole 54, which is connected to the first end of a capacitor 55. Pole 54 may be switched alternately between two throw positions as represented by RUN and REST. The reference RUN refers generally to the position of blade 136 when in sweeping. On the other hand, the reference REST refers generally to the position of blade 136 when in dwelling. The RUN position represents substantially a large portion of a whole round of the rotation angle of the motor shaft, e.g., over 80%. The RUN position is associated with V− and the REST position is associated with V+.

A main switch 56 is provided for activating and deactivating the intermittent operation provided by circuit 50. Switch 56 has a first terminal connected to V− and a second terminal connected to the first end of a variable resistor 58.

The second end of capacitor 55 is connected to the second end of resistor 58. Also connected to the second end of capacitor 55 are the base of transistor 51 and the second end of a resistor 59. The first end of resistor 59 is connected to the first terminal of a STIR switch 60, which can activate a STIR feature, a manually activated continuous operation. The second terminal of switch 60 is associated with V−. The first end of resistor 59 is also connected to the second end of a capacitor 61. The first end of capacitor 61 is connected to V−.

Switch 60 is a push button switch for activating the STIR feature. When switch 60 is pushed, the two terminals are connected, which causes the connection of the first end of resistor 59 to V− and, at the same time, causes capacitor 61 to be short-circuited.

With switch 56 in the activated position and switch 60 in the deactivated position, circuit 50 will operate blade 136 intermittently with a variable dwell period at the end of each sweeping cycle. This intermittent operation is achieved through the circuit of transistor 51, switch 53, capacitor 55, and resistor 58.

Now, to start with, suppose motor 142 has not been operating because switch 56 has been in the deactivated position. Also suppose switch 53 has been in the REST position, and thus capacitor 55 has been discharged.

When switch 56 is activated, the potential at the second end of resistor 58 will be lowered to cause transistor 51 to switch to conductive state, thereby energizing motor 142. As soon as motor 142 begins to rotate, switch 53 will be thrown to the RUN position, which causes the first end of capacitor 55 to be connected to V−. Capacitor 55 will then begin to charge so as to make the second end of capacitor 55 positive with respect to the first end thereof. Sufficient base current will be provided through the base of transistor 51 to cause transistor 51 to remain conductive even after capacitor 55 becomes fully charged, thereby causing motor 142 to continue to rotate throughout a full rotation cycle until switch 53 is cycled back to the REST position. When switch 53 cycles back to the REST position, the first end of capacitor is then connected to V+ and capacitor 55 begins to discharge through resistor 58 until the potential at the second end of resistor 58 becomes sufficiently negative relative to V+. During this period of time, transistor 51 is switched to and remains in non-conductive state, thereby stopping motor 142 for a predetermined interval of time. And then, sufficient base current flow resumes, causing transistor 51 to become conductive again, and a new cycle starts.

The length of the dwell interval is determined by the time required for capacitor 55 to discharge. Proper selection of capacitor 55 and resistor 58 will provide desirable dwell intervals.

With resistor 59 and capacitor 61 in addition, a manually activated continuous blade-sweeping feature can be achieved in addition to and in combination with the controllable variable dwell feature. This performance feature is achieved regardless of whether switch 56 is in the activated position or not when switch 60 is pushed. Moreover, it will be seen if switch 56 is in the activated position when switch 60 is pressed, there will be an immediate override of the intermittent operation. The continuous operation will keep on going without any dwell for a predetermined number of cycles, for example, one or two, after switch 60 is released, before the intermittent operation is resumed. If switch 56 is in the deactivated position when switch 60 is pressed, motor 142 will immediately start to rotate. After switch 60 is released, motor 142 will continue for a predetermined number of continuous sweeping cycles and then stops.

When switch 60 is pressed, the first end of resistor 59 is connected to V−. This allows sufficient current to flow through the base of transistor 51 to switch transistor 51 to conductive state, thereby causing motor 142 to start and operate. By proper selection of the value of resistor 59, this mode of operation will occur regardless of the positions of switches 53 and 56, so long as switch 60 is depressed.

At the same time, pressing switch 60 causes capacitor 61 to be short-circuited such that any charge stored therein is discharged through the short circuit to V−. When switch 60 is released, the current flowing out of the base of transistor 51 will continue through discharged capacitor 61 until capacitor 61 recharges. As a result, transistor 51 will continue in conductive state and motor 142 will continue to operate at the normal speed. Transistor 51 will continue in conductive state for a predetermined period of time based on the time constant provided by resistor 59 and capacitor 61, which are preferably selected to provide one or two continuous sweeping cycles without any dwell after switch 60 is released.

One important point worth mentioning is that if power-drive assembly 140 has a rotation reduction mechanism, linkage 52 should be set between the output shaft of assembly 140 and switch 53, instead of between motor 142 and switch 53.

If multiple rounds of sweeping are desired for a stirring cycle, before one dwell period, e.g., two rounds of sweeping before one dwell period, a pair of gears, or some other mechanisms, should be provided, with the smaller one installed on the output shaft and the larger one cooperating with switch 53. The transfer-ratio should be 1:2.

The intermittent operation of blade sweeping can be alternatively achieved using a mechanically controlled timer, e.g., a spring-driven timer (not shown). Numerous discrete contact poles can be provided on a circular plate, such that when a needle is rotating around a central shaft, the needle engages with each contact pole in sequence. The angle range of each pole represents a stirring cycle. At the end of each stirring cycle, there is a predetermined dwell period, which is represented by the angle range in between two adjacent poles.

In operation, a user is recommended to follow the following steps.

First, charges container 102 with some oil, and then preheats the oil to a predetermined temperature, preferably, halfway boiling. This step can be one step of a cooking program.

Second, charges container 102 with foods to be fried and some necessary ingredients.

Third, selects a temperature, a time duration, and a stirring blade rotation speed, or a program for frying foods, and then pushes on a start button to activate a frying process.

The whole frying process is hand-free. The user does not have to be involved with the frying process until the frying is accomplished or the frying apparatus beeps to remind the user to add more ingredients.

Therefore, a restaurant method includes the following steps: providing a dining area defined by a restaurant building; providing a plurality of dining tables disposed in the dining area; providing a plurality of seats disposed around each dining table; providing a plurality of cook stations, with each disposed on one of the dining tables; providing raw foods; providing additive ingredients; such that diners are provided with options to select among the raw foods and additive ingredients and to cook dishes by themselves; and whereby each dish is individually cooked and customized to diners” preference.

Another restaurant method includes the following steps: Providing a dining area defined by a restaurant building; providing a plurality of dining tables disposed in the dining area; providing a plurality of seats disposed around each dining table; providing a counter having a counter top; providing a plurality of cook stations disposed on the counter top; providing raw foods; providing additive ingredients; such that diners are provided with options to select among the raw foods and additive ingredients and to cook dishes by themselves; and whereby each dish is individually cooked and customized to diners preference.

Accordingly, readers will see that this restaurant method of the present invention can provide diners with healthy and tasteful foods. Diners cook dishes by themselves, such that each dish is individually cooked and customized to diners preference. This restaurant method saves diners time and combines the benefits of fast food restaurants and full service restaurants. In additions, this restaurant method may reduce restaurant-operating costs.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

1. A restaurant method, said restaurant method comprising the steps of:
providing a dining area defined by a restaurant building;
providing a dining table disposed in said dining area;
providing a plurality of seats disposed around said dining table;
providing a stir-frying apparatus disposed on said dining table;
providing raw foods;
providing additive ingredients;
wherein said stir-frying apparatus includes a container having an open top for holding foods, a stirring device installed inside said container for stirring foods disposed inside said container, a power-drive assembly operationally coupled with said stirring device for driving said stirring device through repeating stirring cycles, and a heating device for heating foods disposed inside said container;
wherein diners are provided with options to select among said raw foods and said additive ingredients and to cook various dishes by themselves; and
whereby each dish is individually cooked and customized to diners preference.

2. A restaurant method as defined in claim 1, wherein said raw foods are pre-packed in bags that are adapted for individual dishes.

3. A restaurant method as defined in claim 1, wherein said additive ingredients are pre-packed in bags that are adapted for individual dishes.

4. A restaurant method as defined in claim 1, said restaurant method further including a step of providing a computer for storing various recipes, such that diners can cook various dishes by themselves based on said recipes.

5. A restaurant method as defined in claim 4, wherein said recipes include recipes adapted for weight-conscious diners.

6. A restaurant method as defined in claim 1, said restaurant method further including a step of providing a recipe brochure having various recipes, such that diners can cook various dishes by themselves based on said recipes in said recipe brochure.

7. A restaurant method as defined in claim 6, wherein said recipe brochure includes recipes adapted for weight-conscious diners.

8. A restaurant method as defined in claim 1, wherein said heating device includes a bottom heating element installed underneath said container for heating foods from below and an over-head heating element installed at an upper position of said stir-frying apparatus for heating foods from above.

9. A restaurant method as defined in claim 8, wherein said stir-frying apparatus includes a lid for closing said open top of said container and a housing for heat insulation of said stir-frying apparatus and for adapting said stir-frying apparatus to stand on a flat surface, wherein said lid is hingedly installed at an upper position of said housing, and wherein said overhead heating element is installed on said lid.

10. A restaurant method as defined in claim 9, wherein said stir-frying apparatus includes a venting device having filter means disposed on said lid for cooking fume treatment.

11. A restaurant method as defined in claim 1, wherein said stir-frying apparatus includes a control device for automatically de-energizing said power-drive assembly near the end of each stirring cycle for a predetermined dwell period.

12. A restaurant method as defined in claim 11, wherein said control device includes a switch circuit for de-energizing and energizing said power-drive assembly and a timing circuit to determine said predetermined dwell period.

13. A restaurant method as defined in claim 1, said restaurant method further including a step of providing a plurality of dining tables in said dining area and a plurality of stir-frying apparatuses and wherein each of said stir-frying apparatuses is disposed on each of said dining tables.

14. A restaurant method, said restaurant method comprising the steps of:
providing a dining area defined by a restaurant building;
providing a plurality of dining tables disposed in said dining area;
providing a plurality of seats disposed around each of said dining tables;
providing an counter having a counter top;
providing a plurality of stir-frying apparatuses disposed on said counter top;
providing raw foods;
providing additive ingredients;
wherein each of said stir-frying apparatuses includes a container having an open top for holding foods, a stirring device installed inside said container for stirring foods disposed inside said container, a power-drive assembly operationally coupled with said stirring device for driving said stirring device through repeating stirring cycles, and a heating device for heating foods disposed inside said container;
wherein diners are provided with options to select among said raw foods and said additive ingredients and to cook various dishes by themselves; and
whereby each dish is individually cooked and customized to diners preference.

15. A restaurant, said restaurant comprising:
a dining area defined by a restaurant building;
a dining table disposed in said dining area;
a plurality of seats disposed around said dining table;
a stir-frying apparatus disposed on said dining table; raw foods;
additive ingredients;
wherein said stir-frying apparatus includes a container having an open top for holding foods, a stirring device installed inside said container for stirring foods disposed inside said container, a power-drive assembly operationally coupled with said stirring device for driving said stirring device through repeating stirring cycles, and a heating device for heating foods disposed inside said container;
wherein diners are provided with options to select among said raw foods and said additive ingredients and to cook dishes by themselves; and
whereby each dish is individually cooked and customized to diners preference.

16. A restaurant as defined in claim 15, wherein said raw foods are pre-packed in bags that are adapted for individual dishes.

17. A restaurant as defined in claim 15, wherein said additive ingredients are pre-packed in bags that are adapted for individual dishes.

18. A restaurant as defined in claim 15, said restaurant further including a computer for storing various recipes, such that diners can cook various dishes by themselves based on said recipes.

19. A restaurant as defined in claim 18, wherein said recipes include recipes adapted for weight-conscious diners.

20. A restaurant as defined in claim 15, said restaurant further including a recipe brochure having various recipes, such that diners can cook various dishes by themselves based said recipes in said recipe brochure.

21. A restaurant as defined in claim 20, wherein said recipe brochure includes recipes adapted for weight-conscious diners.

22. A restaurant as defined in claim 15, wherein said stir-frying apparatus includes a bottom heating element installed underneath said container for heating foods from below and an over-head heating element disposed at an upper position of said stir-frying apparatus for heating foods from above.

23. A restaurant as defined in claim 22, wherein said stir-frying apparatus includes a lid for closing said open top of said container and a housing for heat insulation of said stir-frying apparatus and for adapting said stir-frying apparatus to stand on a flat surface, wherein said lid is hingedly installed at an upper position of said housing, and wherein said overhead heating element is installed on said lid.

24. A restaurant as defined in claim 23, wherein said stir-frying apparatus includes a venting device having filter means disposed on said lid for cooking fume treatment.

25. A restaurant as defined in claim 15, wherein said stir-frying apparatus includes a control device for automatically de-energizing said power-drive assembly near the end of each stirring cycle for a predetermined dwell period.

26. A restaurant as defined in claim 25, wherein said control device includes a switch circuit for de-energizing and energizing said power-drive assembly and a timing circuit to determine said predetermined dwell period.

27. A restaurant as defined in claim 15, said restaurant further including a plurality of dining tables in said dining area and a plurality of stir-frying apparatuses and wherein each of said stir-frying apparatuses is disposed on each of said dining tables.
